(19) United States
(12) Patent Application Publication
(10) Pub. No.: US 2012/0298268 A1
(43) Pub. Date: Nov. 29, 2012

(54) METHOD AND DEVICE FOR SUPPRESSING FLAT SPOT OF TIRE

(75) Inventors: Masashi Igarashi, Susono-shi (JP); Ikuo Kushiro, Mishima-shi (JP)

(73) Assignee: Toyota Jidosha Kabushiki Kaisha, Aichi-ken (JP)

(21) Appl. No.: 13/575,441

(22) PCT Filed: Mar. 19, 2010
(86) PCT No.: PCT/JP2010/054883

§ 371 Date: Jul. 26, 2012

(51) Int. Cl. B60C 19/00; B21D 53/26

(52) U.S. Cl. 152/151; 29/894.3

(57) ABSTRACT

There are provided a method and a device to suppress the formation of a flat spot or to lessen the extent of a flat spot in a tire of a vehicle such as automobile by applying to a belt of the tire on a ground contact area of the tire a bending moment in the direction that the opposite sides of the belt are directed outward in the radial direction of the tire to suppress the formation of a deflection due to the compression of a carcass cord on the tire ground contact area In order to apply such a bending moment, a projection member narrower than the tread of the tire is disposed on the surface touching the tire of a vehicle when it is stopped or parked, pressing the tread of the tire.

### FIELD OF THE INVENTION

The present invention relates to a method and a device for suppressing a formation of a flat spot in a tire of a vehicle such as an automobile.

### BACKGROUND ART

It is known that, when a vehicle is stopped in a condition that the temperature of tires has relatively highly increased owing to the driving at high speed or in an environment of a high atmospheric temperature as in the summer or when a vehicle has been parked for a long time, there is formed a “flat spot”, namely, the carcass cord of the tire on its ground contact area (an area in which a tire comes into contact with ground) is deformed flatly along a flat shape of a road surface. Such a flat spot remains for a while after the vehicle is restarted while the tire radius changes at the part of the flat spot, and thereby a vibration is generated in the vehicle every time the flat spot touches the road surface during the tire rotation, deteriorating the riding comfortableness of the vehicle. (During the driving of the vehicle, the flat spot disappears because of the disappearance of the deformation in the carcass cord with gradual warming up of the tire and its temperature increase.)

Then, in the prior art, there have been proposed various countermeasures for suppressing the formation of the above-mentioned flat spot. For example, in Patent Document 1, there is proposed a device which raises up the air pressure in tires when a vehicle is stopped so that a higher tension is applied to the carcass cord than in the driving, thereby decreasing the deflection of the carcass cord on the ground contact area to prevent the formation of a flat spot. In Patent Document 2, it is proposed to dispose a parking pad made of an elastic heat insulating material under a wheel when a vehicle is stopped. Such a parking pad is elastically deformed due to the vehicle weight so as to keep the arcuate shape of the tire so that the flattening of the tire ground contact area can be prevented. Further, Patent Document 3 proposes a parking pad to be disposed under a tire in stopping a vehicle, wherein an upper surface thereof to come into contact with the tire is formed into a sine wave along the longitudinal direction of the tire so that the ground contact area of the tire will be maintained in the arcuate shape without being flattened in the same manner as in Patent Document 2 by making the tire placed on a curved valley portion. Further, Patent Document 4 discloses a material for the carcass cord which is less liable to form a flat spot.
Patent Document 1: Japanese Patent Laid-open Publication No. 2008-006853
Patent Document 2: U.S. Pat. No. 6,344,266
Patent Document 3: U.S. Pat. No. 6,520,344
Patent Document 4: Japanese Patent Laid-open Publication No. 2004-001628

### SUMMARY OF THE INVENTION

### Problem to be Solved by the Invention

The cause of formation of the above-mentioned flat spot is generally said such that the carcass cord, warmed by the heat generated in the tire during the driving and deformed on a flat surface (road surface or support surface) along this surface after the stop of the vehicle, is cooled down, and thereby the flattened deformation of the carcass cord is fixed. Regarding the mechanism of formation of a flat spot, according to the investigations made by the inventors of the present application, it has been clarified that the deformation of a carcass cord leading to a flat spot is owing to a deflection induced by the compression of the carcass cord on a tire ground contact area. More concretely, first, if the rotation of a tire stops while the carcass cord has been softened because of its temperature having reached to the glass transition temperature due to the driving of the vehicle or the heating of the road surface, a deflection of the carcass cord on the tire ground contact area is generated by compression forces applied thereto owing to the load of the vehicle from the opposite sides of the tire. Then, when the temperature of the carcass cord, deflected due to the compression, decreases below the glass transition temperature, the carcass cord is hardened while holding the deflection due to the compression as it is, and the portion in which the deflection due to the compression is kept becomes a flat spot. Indeed, as described in the section of “Description of the Embodiment”, according to the experiments made by the inventors of the present application, it was found that, when a carcass cord, having been softened by heating it up beyond the glass transition temperature, was cooled down while a bending moment in the direction that the opposite sides of the belt of the tire were directed outward in the radial direction of the tire was applied to a belt of the tire on a tire ground contact area to generate tensions in the direction of elongating the carcass cord and to suppress the generation of a deflection owing to the compression therein, only by this, the degree of a flat spot, i.e., the flattening deformation of the tire was substantially decreased. This knowledge can be advantageously utilized to suppress a flat spot of a tire.

Thus, it is a principal object of the present invention to provide a method and/or a device for suppressing the formation of a flat spot or decreasing the extent of the formation thereof by suppressing a deflection of a carcass cord due to its compression on a tire ground contact area by applying a bending moment to a belt of the tire on the ground contact area so that the opposite sides of the belt on the ground contact area of the tire will be directed outward in the radial direction of the tire.

Further, it is another object of the present invention to provide such a method and/or a device as described above which can apply a bending moment to a belt of a tire for suppressing a deflection due to compression of a carcass cord on a ground contact area of the tire with a construction which is as simple as possible.

### Means to Solve the Problem

In the method and the device of the present invention described hereinunder, in brief, based upon the above-mentioned knowledge, in order to suppress a formation of a flat spot or to decrease the extent of a flat spot, the suppression of the formation of a deflection due to compression of a carcass cord on a tire ground contact area, which would cause a flat spot, or the decrease of such a deflection, is done by disposing a projection member narrower than the tread of a tire on the tire ground contact area so as to generate in a belt of a tire a bending moment acting in the direction that the opposite sides of the belt are directed outward in the radial direction of the tire.

Concretely, according to the present invention, as an aspect thereof, there is provided a method for suppressing a formation of a flat spot in a tire of a vehicle comprising the steps of disposing a projection member narrower than a tread of the tire on a surface coming into contact with the tire when the vehicle is stopped or parked, and stopping the vehicle so that the tire is positioned on the projection member, wherein the projection member presses the tread of the tire to apply to a belt of the tire on a ground contact area of the tire a bending moment in a direction that opposite sides of the belt are directed outward in the radial direction of the tire. According to this method, by making the tire ride on the projection member narrower than the tread of the tire when the vehicle is stopped or parked, there is generated a bending moment in the direction that the opposite sides of the belt are directed outward in the radial direction of the tire. When such a bending moment is applied to the belt, there is generated in the carcass cord positioned on the inside of the belt a tension to elongate the belt in the lateral (left and right) direction of the tire, so as to decrease the effect of the compression forces acting vertically downward from the opposite sides of the tire due to the load of the vehicle, and thus a deflection due to the compression of the carcass cord is suppressed or decreased, so that the effect of the suppressing of the formation of a flat spot or the decreasing of the extent thereof will be obtained.

In the above-mentioned structure of the present invention, the shape of the projection member disposed on the tire ground contact area may be optional, provided that it can apply the above-mentioned bending moment to the belt. For example, the projection member may be extended to be longer in the rolling direction of the tire than the tire ground contact area so that the above-mentioned bending moment will be generated in the entire region of the tire ground contact area. Further, since, in a tire for common automobile, grooves of various patterns are formed along a tread thereof, and if the projection member engages into such a groove when the tire rides on the projection member, the bending moment can not be effectively generated. Thus, it is preferable that the projection member has a width wider than the groove width of the tread of the tire. On the other hand, no bending moment for bending the belt in the lateral direction of the tire would be generated if the lateral width of the projection member is equal to or wider than that of the tread, and therefore it is important that the width of the projection member is smaller than that of the tread of the tire. In this regard, the cross sectional shape of the projection member along the lateral direction of the tire may be optional, while according to experiments, it was found that a significant reduction of a flat spot is obtained when the projection member has a height of 1 mm or more from the ground contact area. Further, it was experimentally clarified that the significant effect of the suppression of the formation of a flat spot was obtained even when the lateral position, relative to a tire, of the projection member disposed between the tire and a road surface or support surface did not coincide with the center line of the tire. Namely, in the method of the present invention, it is not necessary to make the center of tire strictly coincide with a projection member disposed on a road surface or support surface in stopping a vehicle, and therefore the present invention is advantageous for the driver in that the adjustment of the lateral position of the vehicle in stopping the vehicle becomes easier.

In an embodiment, the method of the present invention may be applied to a parking area or other parking spaces. Especially, in a parking space, such as a motor pool, a carrier platform of auto-truck or a hold of a vessel, where a plurality of vehicles are parked in series, the projection members may be disposed to extend along linear regions where the tires of the vehicles can be positioned.

The method of the present invention may also be applied to any parking device, for example, a mechanical parking device (device for placing vehicles) used in a multistory car park, etc. Therefore, according to another aspect of the present invention, there is provided a device for parking a vehicle comprising a projection member, narrower than the tread of the tire, to be disposed on a surface coming into contact with a tire of a stopped or parked vehicle, wherein the projection member applies to a belt of the tire on a ground contact area of the tire a bending moment in a direction that opposite sides of the belt are directed outward in the radial direction of the tire during the vehicle being stopped. In such a device, as in the above-mentioned method of the present invention, the projection member may be a member longer than the tire ground contact area along the direction of the tire rotation, a member having a width wider than a groove width of the tread of the tire or a member having a height of 1 mm or more from the tire ground contact area. Further, when the parking device has a parking space for parking a plurality of vehicles in series, the projection member may extend along a linear region on which the tires of the vehicles parked in series can be positioned.

Moreover, the principle of the present invention may be embodied as a device placed on a road surface in a parking area or other parking spaces. Thus, according to another aspect of the present invention, there is provided a device comprising a projection member to be disposed on a ground contact area of a tire of a stopped or parked vehicle, the projection member being narrower than a tread of the tire, wherein the projection member is adapted to apply to a belt of the tire on a tire ground contact area a bending moment in a direction that opposite sides of the belt are directed outward in the radial direction of the tire, thereby suppressing a formation of a flat spot. Also in this case, the projection member may be a member longer than the tire ground contact area in the direction of the tire rotation, a member having a width wider than a groove width of a tread of the tire, and/or a member having a height of 1 mm or more from the tire ground contact area. As described in the section of embodiment, such a device may be employed as accompanying a bumper in a parking area.

### Effects of the Invention

In the prior art like those described in the section of Background Art, mostly, it is attempted to suppress the formation of a flat spot by maintaining an arcuate shape on the ground contact area of a tire in a parked vehicle. In contrast, in the present invention, the suppression of the formation of a flat spot is accomplished according to a new principle that deflection due to compression of a carcass cord on the inside of a belt is decreased or suppressed by applying, to the belt on the tire ground contact area in the stopping or parking of a vehicle, a bending moment in the direction that the opposite sides of the belt are directed outward in the radial direction of the tire. Particularly, according to the principle of the present invention, the flat spot formation is suppressed by disposing a projection member on a ground contact area of a tire, and therefore the steps in the method or the structure of the device are advantageously simple as compared with the conventional methods or devices. For example, in the present invention, no complicated structures as in the system for raising the pneumatic pressure of a tire in parking a vehicle, as described in Patent Document 1, is required. Further, as will be understood in the section of Description of the Embodiment, the projection member according to the present invention may be made extend beyond a ground contact area of a tire in the longitudinal direction of the tire, and thus, in the present invention, there is no limitation as in Patent Documents 2 and 3 that the tire must be stopped on the parking pad to definitely coincide therewith in the longitudinal direction in parking a vehicle, so that the user can stop a vehicle more easily than in the conventional art. Further, a projection member prepared according to the principle of the present invention may be a member such as a bar made of iron or a rope, etc., and therefore, the present invention can advantageously be practiced at a relatively low cost.

Other objects and advantages of the present invention will be partly clear or pointed out in the following descriptions.

### BRIEF DESCRIPTION OF THE DRAWINGS

FIGS. 1 (A) and (C) are schematic side views of a tire of a parked vehicle, and FIGS. 1 (B) and (D) are sectional views seen from the longitudinal direction of the tire. (A) and (B) show a case where no projection member is disposed on a tire ground contact area, while (C) and (D) show a case where a projection member is disposed on a tire ground contact area according to the present invention. FIG. 1 (E) is a drawing to explain the force and the moment to act in the belt and the carcass cord of a tire when a projection member is disposed on tire ground contact area of the tire.

FIG. 2 shows results of rotational vibration experiments of a tire to examine the extent of a flat spot formed in cases where projection members were disposed on a surface touching a tire in various conditions. (A), (B) and (C) show the results when changing conditions of the height of the projection member from the surface touching the tire, the lateral position of the projection member, and the orientation of the projection member, respectively. In the respective graphs, the time of the abscissa is the lapse of time from the start of rotation of the tire after the flat spot has been formed.

FIG. 3 (A) is a schematic view of a case where the present invention is applied to a bumper for a vehicle. FIG. 3 (B) is a schematic view of a case where the present invention is applied to a parking area or other parking spaces, FIG. 3 (C) is a schematic (front) view of a case where the present invention is applied to a platform for a vehicle of a parking device, and FIG. 3 (D) is a schematic (plan) view of a case where the present invention is applied to vehicles parked in series in a motor pool, a load-carrying platform of an auto-truck or a hold of a vessel.

### EXPLANATION OF REFERENCE NUMERALS

10 . . . Vehicle
12 . . . Tire
14 . . . Tire ground contact area
20 . . . Rubber layer
22 . . . Carcass cord
24 . . . Bead
26 . . . Tire tread
28 . . . Groove of tire tread
30 . . . Belt
40 . . . Bumper
44 . . . Section line
50 . . . Vehicle-carrying platform of a parking device
Pr . . . Projection member
R . . . Road surface or vehicle support surface

### DESCRIPTION OF THE EMBODIMENTS

In the following, the present invention will be described in detail with respect to some preferred embodiments by referring to the accompanying drawings. In the drawings, the same portions are referred to by the same reference numerals.

Principle of the Present Invention

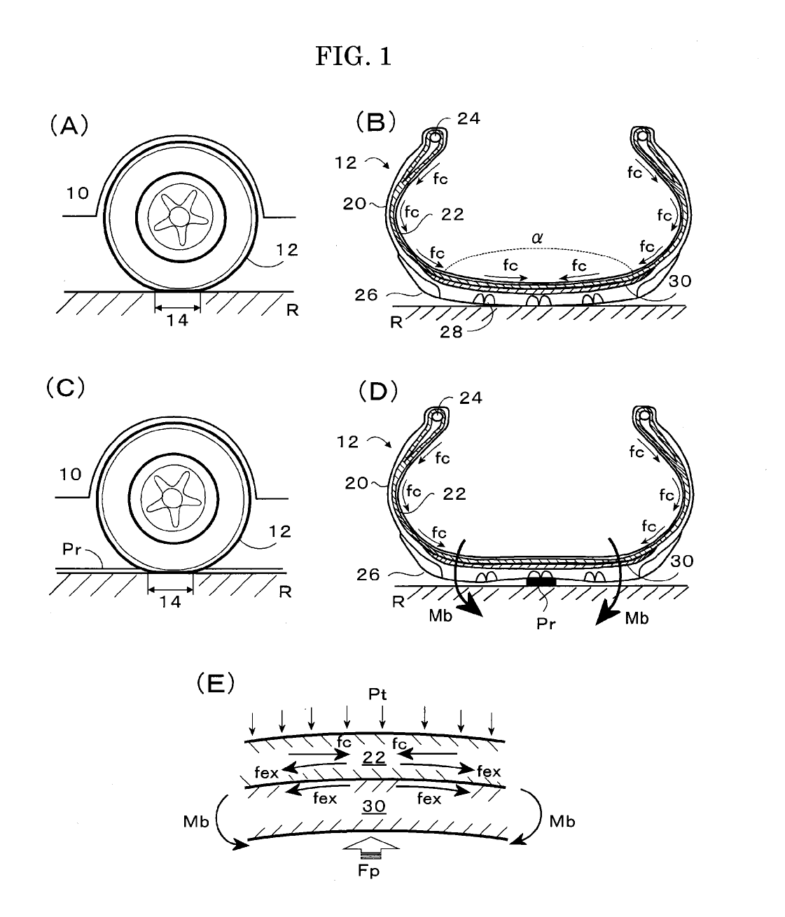

Referring first to FIGS. 1 (A) and (B), on the surface of a tire 12 touching a road surface (or supporting surface) R or a ground contact area 14 in a stopped vehicle 10 such as an automobile, the pressure (not shown in the figure) acting from the surface R and the internal pressure (not shown in the figure) of the tire are balanced against each other with interposition of a tire's tread portion 26, and thus the ground contact area 14 of the tire is deformed to be approximately flat along the flat shape of the road surface as shown in FIG. 1 (A). Then, with reference to the inside of the tire in this case, as shown in FIG. 1 (B), a carcass cord 22 covered with a rubber layer 20 of the tire 12 receives downward forces fc owing to the load of the vehicle from the opposite left and right sides of the tire, and accordingly compressing forces act on the region, indicated by α, in the inside of a belt 30. In this regard, after the vehicle running at high speed or in a high temperature environment as in the summer, the temperature of the tire may exceed beyond the glass transition temperature of the carcass cord 22, and in that case, since the carcass cord 22 becomes softened to be liable to deform, it is considered that the degree of the distortion or deflection owing to the compression in the direction along the surface R in the carcass cord on the inside of the belt 30 (region α) is much increased by the above-mentioned compressing forces. Then, when the tire is cooled down and the temperature of the carcass cord 22 becomes lower than its glass transition temperature, the carcass cord 22 is hardened while the degree of the distortion or deflection due to the compression has been increased, and it is considered that the distortion or deflection which remains in the hardening of the carcass cord becomes a flat spot.

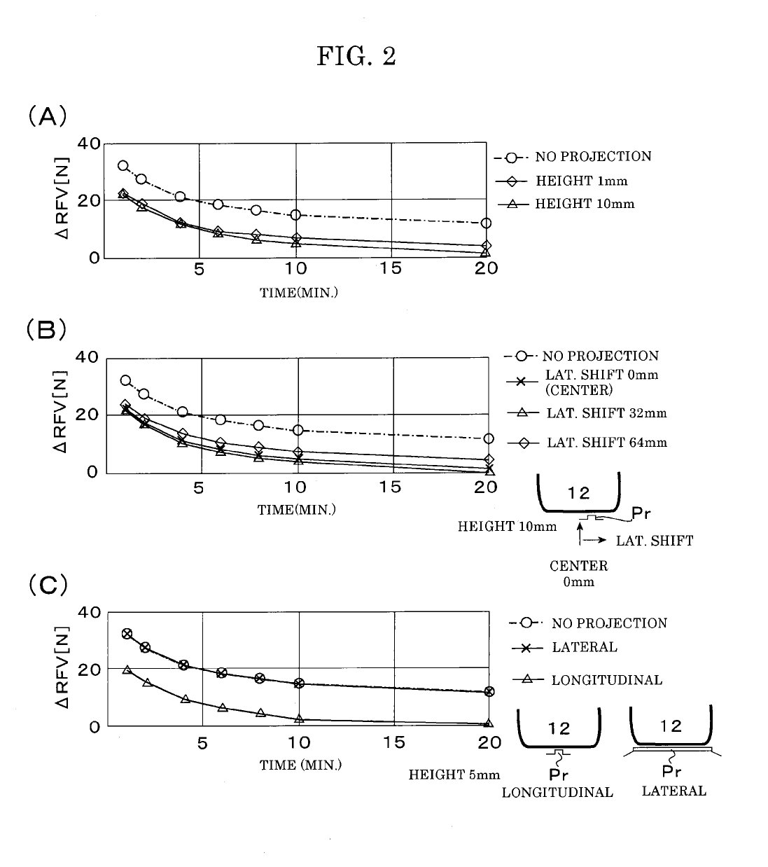

Thus, in the present invention, it is attempted to suppress or decrease the formation of a flat spot by suppressing the distortion or deflection due to the compression of the carcass cord 22 on the inside of the belt 30 when the vehicle is stopped or parked. Concretely, as schematically shown in FIGS. 1 (C) and 1 (D), on the ground contact area 14 of the tire, there is disposed a projection member Pr which presses the tread 26 and the belt 30 from the downside thereof to apply to the belt 30 a bending moment Mb in the direction that the left and right of the belt 30 are directed outward in the radial direction of the tire, in other words, a moment which bends a central portion of the belt 30 inwardly approximately along the direction of the tire rotation. When the belt 30 is pressed from its downside by the projection member Pr (Fp), the belt 30 is not broken, because of its comparative rigidity, but moderately bent inwardly as schematically shown in FIG. 2 (E) according to the balance between the pressing force Fb by the projection member and the tire internal pressure Pt. Then, in accordance with the moderate bending, the radially inside surface portion of the belt 30 is elongated, and together with this, there are generated tensions fex which pull the carcass cord 22 attached on the inside surface of the belt 30 in the lateral direction of the tire. The tensions fex cancel at least a part, more desirably totally, the compressing forces fc, whereby the distortion or deflection due to the compression of the carcass cord 22 which would cause a flat spot is dissolved or lessened so that the formation of a flat spot will be suppressed.

Experiment for Confirming the Principle of the Present Invention

In order to confirm the principle of the present invention, i.e., that the formation of a flat spot in a tire can be suppressed or lessened by disposing on a tire ground contact area a projection member that applies a bending moment to the belt 30 of the tire in the direction that the left and right sides of the belt 30 are directed outward in the radial direction of the tire, various projection members were disposed on the tire ground contact area in experimentally forming a flat spot in the tire, and the extent of formation of the flat spot was examined.

The experiments were carried out as follows.

(1) First, a tire was rotated in a condition corresponding to an actual high speed driving of a vehicle. By this tire rotation, the temperature of the carcass cord is increased to exceed beyond the glass transition temperature and the carcass cord is softened. In this regard, the rise of the temperature of the carcass cord beyond the glass transition temperature was checked by measuring the temperature of the tire with a thermocouple.
(2) After the above process, the rotation of the tire was stopped, and then, while a projection member was disposed between the tire and a flat supporting surface (tire ground contact area) in various conditions, and the tire was set in a standstill condition that a flat spot would be formed normally (if no projection member was disposed) (a flat spot forming process). In the meantime, the temperature of the carcass cord was cooled down below the glass transition temperature and the carcass cord was hardened. That the temperature of the carcass cord was decreased below the glass transition temperature was checked by measuring the temperature of the tire with a thermocouple.
(3) Thereafter, while the tire was rotated in a condition corresponding to a normal driving of the vehicle, a time-based change of amplitude of the force acting on the rotation shaft of the tire, ΔRFV, was measured. Herein, ΔRFV is a value obtained by subtracting the amplitude of the force acting on the rotation shaft of the tire before the flat spot forming process from the amplitude of the force acting on the rotation shaft of the tire after the flat spot forming process according to the above processes (1) and (2). This ΔRFV is an index which indicates the extent of a formed flat spot, namely, the larger this value is, the more violent the variation of the force acting on the tire rotation shaft is, i.e. the larger flat spot has been formed.

FIG. 2 shows the results of ΔRFV measured by the above-mentioned processes by employing projection members of various conditions. In the experiments described below, a tire identified by “245/70R17” was used, and for a projection member used during keeping the tire still of the tire in the process (2), a steel bar having a width of 20 mm and a length extending beyond the tire ground contact area was used. The reason for using the member having 20 mm width is to prevent the projection member from engaging into the groove of the tread of the tire.

First, in FIG. 2 (A), there are shown the variations in time of ΔRFV value in the case that the flat spot forming process was carried out with no projection member (white circles in the drawing), ΔRFV value in the case that the flat spot forming process was carried out with a projection member of 1 mm height being disposed on the tire ground contact area to extend approximately along on the central line in the direction of the tire rotation (white squares in the drawing), and ΔRFV value in the case that the flat spot forming process was carried out with a projection member of 10 mm height being disposed on the tire ground contact area to extend approximately along on the central line in the direction of the tire rotation (white triangles in the drawing) (The ordinate shows values normalized with the initial value of ΔRFV value (ΔRFVo) in the case that the flat spot forming process was carried out without projection member.) As seen in this figure, while the ΔRFV value in each case decreased gradually with the lapse of time after the starting of the tire rotation, ΔRFV values in the cases that the projection member was disposed on the tire ground contact area, both in the cases of the height of 1 mm and 10 mm, significantly decreased just after the rotation start, as compared with the ΔRFV value in the case that no projection member was disposed on the tire ground contact area. From these results, it has been confirmed that the formation of the flat spot can be substantially suppressed by employing a projection member of a height higher than 1 mm.

Next, FIG. 2 (B) shows ΔRFV values in the cases wherein the position of disposing the projection member of the height of 10 mm in the flat spot forming process was shifted in the direction perpendicular to the direction of the tire rotation (the lateral direction of the tire) (The ordinate shows values normalized with the initial value of ΔRFV value (ΔRFVo) in the case that the flat spot forming process was carried out without projection member.). As seen in this figure, in the tire having a width of 245 mm, there were no significant differences in ΔRFV values in the case that the position of the projection member was shifted by 32 mm from the center (white triangles in the drawing) and also in the case that the projection member was shifted by 64 mm from the center (white squares in the drawing) as compared with ΔRFV value in the case that the projection member was disposed on the approximate center position of the tire (x in the drawing), and accordingly, it has been confirmed that the formation of a flat spot can be substantially suppressed. This result suggests that the substantial suppression of the formation of a flat spot can be achieved even without letting the position of a projection member on a tire ground contact area coincide strictly with the center of the tire.

Further, FIG. 2 (C) shows the variations in time of the ΔRFV value in the case that the above-mentioned flat spot forming process was carried out while a projection member (5 mm height) was disposed on the tire ground contact area such that the direction of the projection member was directed perpendicular to the direction of the tire rotation (the condition indicated by “LATERAL” as shown in the right bottom portion of the figure) (x in the drawing), and the ΔRFV value in the case that the flat spot forming process, similar to the above, was carried out while the similar projection member was disposed on the tire ground contact area such that the direction of the projection member was directed along the direction of the tire rotation (the condition indicated by “LONGITUDINAL” as shown in the right bottom portion of the figure) (white triangles in the drawing) (The ordinate shows values normalized with the initial value of ΔRFV value (ΔRFVo) in the case that the flat spot forming process was carried out without projection member.). In that case, as readily seen in the figure, the ΔRFV value in the case that the projection member was disposed perpendicular to the direction of the tire rotation was generally the same as in the case that the flat spot forming process was carried out without projection member, where no suppression of the formation of the flat spot was attained. In the case that the projection member extends perpendicular to the direction of the tire rotation, namely crossing the tire in the lateral direction, it is considered that no bending moment which bends the belt in the direction that the left and right sides of the belt are directed outward in the radial direction of the tire as described above is generated, and in turn, no tension for elongating the softened carcass cord in the lateral direction of the tire is generated. Thus, the result shown in FIG. 2 (C) suggests that the formation of a flat spot can be suppressed by applying a bending moment to the belt in the direction that the lef and right sides of the belt are directed outward in the radial direction of the tire to suppress the formation of the deflection due to the compression of the carcass cord.

From the above results, it has been confirmed that, according to the principle of the present invention, the formation of a flat spot can be significantly suppressed by disposing a projection member narrower than the width of the tread of a tire on a tire ground contact area so as to generate a bending moment in the direction that the left and right of a belt are directed outward in the radial direction of the tire.

Construction of the Embodiments of the Present Invention

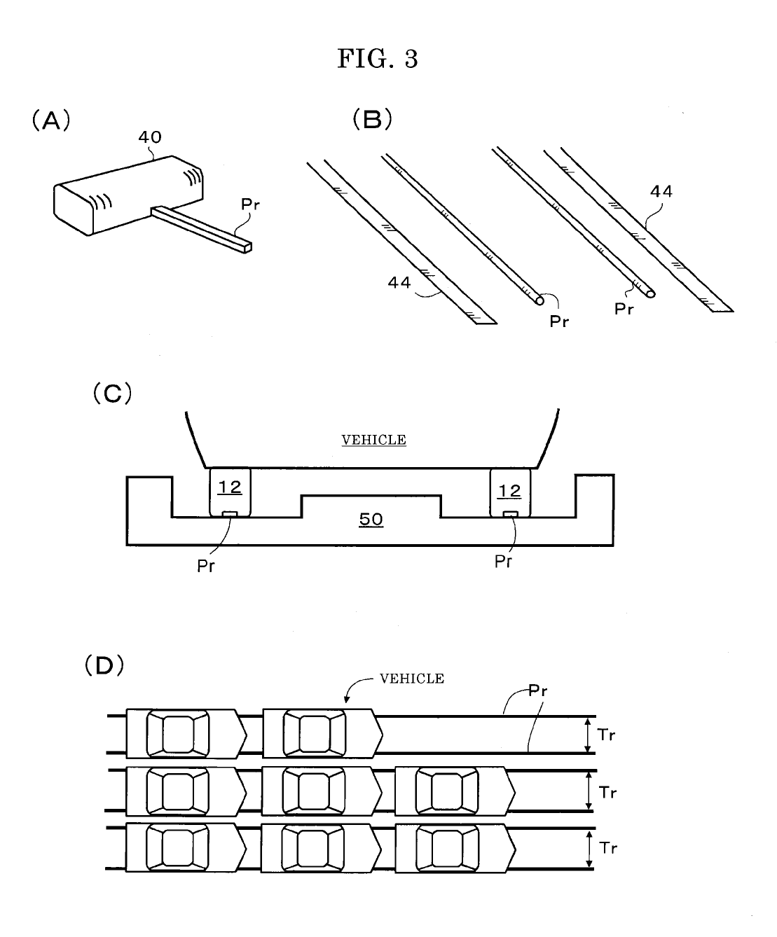

The method for suppressing the formation of a flat spot according to the present invention using the above-mentioned principle of the present invention may be practiced in arbitrary manners. For example, one embodiment of the method of the present invention may be accomplished by forming or placing a construction where a projection member Pr is attached to a bumper 40 as illustrated in FIG. 3 (A). (The bumper 40 attached with the projection member Pr is an example of the device for suppressing a flat spot of a tire.) With reference to the results of the above-mentioned experiments, the size of the projection member Pr may be such that, for example, the horizontal width is large enough not to engage into the groove of the tread of the tire (approx. 20 mm), the height is 1 mm or more (desirably 5 mm-10 mm), and the length is longer than the longitudinal length of the ground contact area of the tire in the direction of the tire rotation (e.g. more than 100 mm). In this connection, it should be understood that the direction of extension of the projection member Pr need not necessarily be made coincide with the center line of the tire in the direction of the tire rotation as long as the above-mentioned bending moment is generated thereby. Although there is no limit in the height of the projection member, it should preferably be the level at which the opposite sides of the tire do not float up from the ground contact area of the tire in view of the stability of the stopped vehicle. The material of the projection member Pr may be an arbitrary material that is rigid enough for the applying of the significant bending moment when a tire is placed on the projection member, which material may be such as appropriate metal, iron, hard plastic, stone, cement, wire, rope, etc. Moreover, the device in FIG. 3 (A) need not necessarily be fixed to a road surface or a parking space, and may be movable as to be arbitrarily replaced by the user. When a bumper is constructed as shown in FIG. 3 (A), the driver may stop a vehicle so that a tire stops in contact with the bumper 40, whereby the projection member Pr is positioned generally in alignment with the tire in the direction of the tire rotation so that the formation of a flat spot in the tire will be suppressed or lessened in the restarting of the vehicle.

For another embodiment, as schematically shown in FIG. 3 (B), a projection member Pr may be placed or constructed in a linear or strip region on which a tire will be stopped in a parking area or other parking space. In this case, the projection member may be an arbitrary elongated member made of an arbitrary metal or iron, hard plastic, stone, cement, wire or rope. The sectional size of such a projection member may be the same as in the case of FIG. 3 (A) such that the horizontal width is large enough not to engage into the groove of the tread of the tire (approx. 20 mm) and the height is 1 mm or more (desirably 5 mm-10 mm). The projection member Pr need not be arranged to extend strictly straight, and even though there exists a more or less curved or broken portion therein, if it is within an extent that allows applying an effective bending moment as described above to the belt of the tire when it is placed on the projection member, the operational effect of the present invention can be achieved, and thus, it should be understood that such cases are included within the scope of the present invention. According to this structure, in the parking of a vehicle, when the driver makes the positioning of the vehicle between a pair of sectioning lines 44 while observing these lines and stops it, the projection members Pr will be disposed under the tires. Also, in a case that the projection members Pr extends generally over the entire length of the area between the sectioning lines 44 on which a vehicle is to be accommodated, the projection members Pr can be positioned under tires even if the driver does not strictly adjust the longitudinal position of the vehicle, and thus, the effect of suppressing the formation of a flat spot can be achieved.

For still another embodiment of the present invention, as schematically shown in FIG. 3 (C), a projection members Pr according to the present invention may be provided on a site on which a tire 12 is positioned when a vehicle is loaded in a platform 50 of a parking device used in a multistory car park or a parking device mounted on the load-carrying platform of an auto-truck for carrying a vehicle(s). In this structure, although not shown in the drawing, a bumper 40 accompanying the projection member Pr as shown in FIG. 3 (A) may be placed or formed on the platform 50. The projection member Pr may be of a removable type, and further, may be provided only at a portion to become a tire ground contact area, and in that case, the position of the projection member Pr may be adjustable according to the distance between axles of a vehicle. Or alternatively, the projection member Pr may be provided to extend over the entire longitudinal area of the platform. The sectional size of the projection member Pr may be the same as in the case of FIG. 3 (A) such that the horizontal width is large enough not to engage into the groove of the tread of the tire (approx. 20 mm) and the height is 1 mm or more (desirably 5 mm-10 mm).

For still other embodiment, as in FIG. 3 (D), the present invention may be applied to such a case that a plurality of vehicles are parked in series in a large parking area, a motor pool, a load-carrying platform of a vehicle-carrying auto-truck, a hold of a vessel, etc. In this case, continuous projection members Pr are placed or formed along each of a pair of linear or strip regions, spaced apart by a tread width Tr of a vehicle from one another, on which regions tires of a plurality of vehicles parked in series can be positioned. The projection members Pr may be constructed, for example, by forming linear constructions having a horizontal width large enough not to engage into the groove of the tread of the tire (approx. 20 mm) and a height of 1 mm or more (desirably 5 mm-10 mm) or by placing bar members or ropes of said size on a parking space. In this structure, the drivers or transporters of the vehicles will park vehicles in series such that the opposite wheels of the vehicles are placed on the projection members Pr without much getting out of their positions. In this case, as is in the case of FIG. 3 (B), since the projection members Pr extend over the entire regions of the linear or strip areas, the effect of reducing a flat spot according to the present invention can be obtained without strict adjustment of the longitudinal positions of vehicles parked in series. Further, in the same manner as in the case of FIG. 3 (B), the projection members Pr need not be extended strictly straight, and even though there exists a more or less curved or broken portion therein, if it is within an extent that allows applying an effective bending moment as described above to the belt of the tire when it is placed on the projection member, the operational effect of the present invention can be achieved, and thus, it should be understood that such cases are included within the scope of the present invention.

Although the present invention has been described in detail with respect to some specific embodiments thereof in the above, it will be apparent for those skilled in the art that the present invention is not limited to the above-mentioned embodiments, and other various embodiments are possible within the scope of the present invention.

For example, the concrete embodiments of the method and the device of the present invention and the shape of the projection member may be changed in various manners within the scope of the present invention, belonging to the scope of the present invention. The important matter is to dispose a projection member on a tire ground contact area to generate in the belt of the tire a bending moment in the direction that a central portion of the belt of the tire is bent inwardly, namely, that the opposite left and right sides of the belt are directed outward in the radial direction of the tire, thereby relieving the deflection or distortion due to the compression of the carcass cord on the inside of the belt.

1. A method for suppressing a formation of a flat spot in a tire of a vehicle comprising the steps of disposing a projection member narrower than a tread of the tire on a surface coming into contact with the tire of the vehicle when the vehicle is stopped or parked, and stopping the vehicle so that the tire is positioned on the projection member, wherein the projection member presses a part of the tread to apply to a belt on a ground contact area of the tire a bending moment in a direction that opposite sides of the belt are directed outward in a radial direction of the tire.

2. The method of claim 1, wherein the projection member is extended longer than the ground contact area of the tire in a direction of rotation of the tire.

3. The method of claim 1, wherein, as the projection member, a projection member having a height of 1 mm or more is used.

4. The method of claim 1, wherein, as the projection member, a projection member having a width wider than a groove width of the tread of the tire is used.

5. The method of claim 1, wherein, in a parking space in which a plurality of vehicles are to be parked in series, the projection member is made extend along a linear region in the parking space on which region tires of the plurality of vehicles parked can be positioned.

6. A device comprising a projection member to be disposed on a ground contact area of a tire of a vehicle when the vehicle is stopped or parked, the projection member being narrower than a tread of the tire, and the projection member applying to a belt on the ground contact area of the tire a bending moment in a direction that opposite sides of the belt are directed outward in a radial direction of the tire to suppress formation of a flat spot in the tire of the vehicle.

7. The device of claim 6, wherein the projection member is a member longer than the tire ground contact area in a direction of rotation of the tire.

8. The device of claim 6, wherein the projection member is a member having a height of 1 mm or more from the ground contact area of the tire.

9. The device of claim 6, wherein the projection member is a member having a width wider than a groove width of the tread of the tire.

10. A device for parking a vehicle, the device comprising a projection member disposed on a surface coming into contact with a tire of the vehicle when it is stopped or parked, the projection member being narrower than the tread of the tire, and the projection member applying to a belt on a ground contact area of the tire a bending moment in a direction that opposite sides of the belt are directed outward in a radial direction of the tire.

11. The device of claim 10, wherein the projection member is a member longer than the ground contact area of the tire in a direction of rotation of the tire.

12. The device of claim 10, wherein the projection member is a member having a height 1 mm or more from the ground contact area of the tire.

13. The device of claim 10, wherein the projection member is a member having a width wider than a groove width of a tread of the tire.

14. The device of claim 10, comprising a parking space in which a plurality of vehicles are parked in series, wherein the projection member extends along a linear region in the parking space on which region tires of the plurality of vehicles parked in series can be positioned.
